(19) United States
(12) Patent Application Publication
(10) Pub. No.: US 2026/0105616 A1
(43) Pub. Date: Apr. 16, 2026

(54) METHOD AND APPARATUS FOR AXIAL MOTION MAGNIFICATION IN A VIDEO

(71) Applicant: POSTECH RESEARCH AND BUSINESS DEVELOPMENT FOUNDATION, Pohang-si (KR)

(72) Inventors: ByungKi Kwon, Pohang-si (KR); TAEHYUN OH, Pohang-si (KR); HYUNBIN OH, Pohang-si (KR); JUNSEONG KIM, Pohang-si (KR); Hyunwoo Ha, Pohang-si (KR)

(73) Assignee: POSTECH RESEARCH AND BUSINESS DEVELOPMENT FOUNDATION, Pohang-si (KR)

(21) Appl. No.: 19/355,924

(22) Filed: Oct. 10, 2025

(30) Foreign Application Priority Data
Oct. 15, 2024 (KR) 10-2024-0140333

(51) Int. Cl. G06T 7/246; G06T 3/40

(52) U.S. Cl. CPC G06T 7/246; G06T 3/40

(57) ABSTRACT

A method for axial motion magnification in a video according to a first aspect of the present invention includes acquiring a feature vector, which is a representation in a predetermined coordinate system, from each of a plurality of images included in a video; acquiring projection values in a motion magnification direction defined on the coordinate system from each of the feature vectors; acquiring a difference between the projection values; and acquiring a magnification result for motion in the video in the motion magnification direction based on a representation of the acquired difference in the coordinate system.

### CROSS-REFERENCE TO RELATED APPLICATION

This application claims priority to Korean Patent Application No. 10-2024-0140333, filed on Oct. 15, 2024, the entirety of which is incorporated herein by reference for all purposes.

### TECHNICAL FIELD

The present invention relates to a method and apparatus for axial motion magnification in a video.

This work was supported by Institute of Information & communications Technology Planning & Evaluation (IITP) grant funded by the Korea government (MSIT) (No. 2022-0-00124, No. RS-2022-II220124, Development of Artificial Intelligence Technology for Self-Improving Competency-Aware Learning Capabilities, 2022/04/01˜2026/12/31), the National Research Foundation of Korea (NRF) grant funded by the Korea government (MSIT) (No. RS-2024-00358135, Corner Vision: Learning to Look Around the Corner through Multi-modal Signals, 2024/05/01˜2028/04/30), and Institute of Information & communications Technology Planning & Evaluation (IITP) grant funded by the Korea government (MSIT) (No. RS-2024-00457882, National AI Research Lab Project, 2024/07/01˜2028/12/31).

### BACKGROUND

Motion magnification is a method for amplifying subtle motions in a video that are difficult to detect with the naked eye, enabling a user to easily perceive them. Using motion magnification, diagnostic tasks such as failure diagnosis of rotating machinery or defect diagnosis of buildings can be performed by analyzing only the video acquired using a camera in situations where such diagnoses are required.

Particularly, in the failure diagnosis of rotating machinery or defect diagnosis of buildings, the analysis of vibration magnitude and vibration frequency is an essential element. In this case, since the analysis of vibration magnitude and frequency is performed after first determining the direction, the analysis of motion in a specific direction can be important.

However, because conventional motion magnification amplifies motion in all directions, it is not possible to separate and extract information about motion in a specific direction, which makes it is difficult for a user to accurately perceive information about motion in a specific direction from the magnified video.

### SUMMARY

An object of the present invention includes providing a magnification result in which motion in a video is magnified in a motion magnification direction input by a user.

However, the problems to be solved by the present invention are not limited to those mentioned above, and other unmentioned problems will be clearly understood by those of ordinary skill in the art from the following description.

A method for axial motion magnification in a video according to a first aspect of the present invention comprises acquiring a feature vector, which is a representation in a predetermined coordinate system, from each of a plurality of images included in a video; acquiring projection values in a motion magnification direction defined on the coordinate system from each of the feature vectors; acquiring a difference between the projection values; and acquiring a magnification result for motion in the video in the motion magnification direction, based on a representation of the acquired difference in the coordinate system.

The coordinate system may be an orthogonal coordinate system on a two-dimensional plane.

The Projection Values May Include a Component Along the Motion Magnification Direction and a Component in a Direction Perpendicular to the Motion Magnification Direction.

The motion magnification direction may be acquired from a user or a pre-trained motion direction recommendation model.

Training input data and training ground truth data may be used in a training process of the motion direction recommendation model. In this case, the training input data may include a video of an object having motion, and the training ground truth data may include information on the motion direction requiring magnification in the video of the training input data.

The difference may include a first difference between respective projection values obtained by projecting each feature vector onto the component along the motion magnification direction, and a second difference between respective projection values obtained by projecting each feature vector onto the component in the direction perpendicular to the motion magnification direction.

The magnification result may be acquired by magnifying the first difference in the motion magnification direction and magnifying the second difference in the direction perpendicular to the motion magnification direction.

The magnification may reflect a first motion magnification factor input by a user to the first difference, and reflect a second motion magnification factor input by the user to the second difference.

The plurality of images may include a plurality of objects or a plurality of regions. In this case, the method may further comprise selecting one of a predetermined object or a predetermined region included in the plurality of images. Furthermore, the acquiring the magnification result, the motion for the selected predetermined object or the selected predetermined region may be magnified.

A method for axial motion magnification in a video according to another embodiment of the first aspect of the present invention comprises inputting a plurality of images included in a video, selecting a motion magnification direction, and acquiring a magnification result for motion in the video in the motion magnification direction using a pre-trained motion magnification model.

A method for training a motion magnification model according to still another embodiment of the first aspect of the present invention comprises inputting a plurality of images included in a video to the motion magnification model; inputting a motion magnification direction and a magnification map corresponding to a predetermined object included in the plurality of images; generating a motion-magnified image by magnifying the motion of the predetermined object using the motion magnification model based on the motion magnification direction and the magnification map; and calculating a loss based on the generated motion-magnified image and training ground truth data, and updating parameters of the motion magnification model.

The generating the motion-magnified image may include acquiring a feature vector, which is a representation in a predetermined coordinate system, from each of a plurality of images included in the video; acquiring projection values in a motion magnification direction defined on the coordinate system from each of the feature vectors; acquiring a difference between each of the projection values; and acquiring a magnification result for motion in the video in the motion magnification direction based on a representation in the coordinate system for the acquired difference.

The coordinate system may be an orthogonal coordinate system on a two-dimensional plane.

The projection value may include a component along the motion magnification direction and a component in a direction perpendicular to the motion magnification direction.

The plurality of images may include a first image and a second image in a consecutive frame relationship with the first image. In this case, the first image may be generated based on a plurality of images included in a dataset and a plurality of layer masks respectively corresponding to objects within each image. Furthermore, the second image may be generated based on the first image and a layer mask to which a translation by a predetermined algorithm has been applied.

The motion magnification direction may be determined by a predetermined algorithm.

The training ground truth data may be generated by magnifying the motion of the predetermined object based on the arbitrarily determined motion magnification direction and a motion magnification factor applied to a layer mask corresponding to the first image and the second image.

The magnification map may be generated based on a motion magnification factor and a layer mask corresponding to the first image and the second image.

An apparatus for axial motion magnification in a video according to a second aspect of the present invention comprises a memory capable of storing computer-executable instructions, and a processor that, by executing the instructions, acquires a feature vector, which is a representation in a predetermined coordinate system, from each of a plurality of images included in a video; acquires projection values in a motion magnification direction defined on the coordinate system from each of the feature vectors; acquires a difference between the projection values; and acquires a magnification result for motion in the video in the motion magnification direction based on a representation of the acquired difference in the coordinate system.

A non-transitory computer-readable storage medium according to a third aspect of the present invention stores computer-executable instructions, wherein the computer-executable instructions, when executed by a processor, cause the processor to perform a method comprising acquiring a feature vector, which is a representation in a predetermined coordinate system, from each of a plurality of images in a consecutive frame relationship included in a video; acquiring projection values in a motion magnification direction defined on the coordinate system from each of the feature vectors; acquiring a difference between each of the projection values; and acquiring a magnification result for motion in the video in the motion magnification direction based on a representation in the coordinate system for the acquired difference.

A computer program stored on a non-transitory computer-readable storage medium according to a fourth aspect of the present invention comprises instructions for causing a processor, when the computer program is executed by the processor, to perform a method comprising acquiring a feature vector, which is a representation in a predetermined coordinate system, from each of a plurality of images in a consecutive frame relationship included in a video; acquiring projection values in a motion magnification direction defined on the coordinate system from each of the feature vectors; acquiring a difference between each of the projection values; and acquiring a magnification result for motion in the video in the motion magnification direction based on a representation in the coordinate system for the acquired difference.

According to the above aspects, complex and subtle movements of various structures or machines may be provided to a user concisely and clearly.

Furthermore, motion in a specific direction, which is difficult to analyze with conventional motion magnification techniques, may be accurately analyzed.

The effects obtainable from the present invention are not limited to the effects mentioned above, and other unmentioned effects will be clearly understood by those of ordinary skill in the art to which this disclosure pertains from the following description.

### BRIEF DESCRIPTION OF THE DRAWINGS

FIG. 1 is a block diagram illustrating an exemplary axial motion magnification apparatus for a video according to an embodiment.

FIG. 2 is a block diagram illustrating exemplary functions of an axial motion magnification program for a video.

FIG. 3 is a flowchart illustrating an exemplary method for axial motion magnification in a video according to an embodiment.

FIG. 4 is a flowchart illustrating an exemplary method for axial motion magnification in a video according to another embodiment.

FIG. 5 is a flowchart illustrating an exemplary method for training an axial motion magnification model for a video according to yet another embodiment.

FIG. 6 is an exemplary diagram illustrating the structure of an axial motion magnification model for a video according to an embodiment.

FIG. 7 is an exemplary diagram illustrating a shape branch included in the axial motion magnification model for a video according to FIG. 6.

FIG. 8 is an exemplary diagram illustrating a manipulator included in the axial motion magnification model for a video according to FIG. 6.

FIG. 9 is an exemplary diagram illustrating the concept of projection (a) and inverse projection (b) of an axial motion magnification model for a video.

FIG. 10 is an exemplary diagram illustrating a training dataset for training an axial motion magnification model for a video.

FIG. 11 is an exemplary diagram illustrating the training of an axial motion magnification model for a video using a motion magnification direction and a magnification map.

FIG. 12 is an exemplary diagram illustrating the generation of a training dataset for training an axial motion magnification model for a video.

FIG. 13 is an exemplary diagram illustrating the analysis of the rotating motion of a rotating machine using a conventional motion magnification technique and a method for axial motion magnification in a video according to an embodiment of the present invention, respectively.

FIG. 14 is an exemplary diagram illustrating an apparatus for simulating a motor shaft and the motion analysis results thereof, using a conventional motion magnification technique and a method for axial motion magnification in a video according to an embodiment of the present invention.

FIG. 15 is an exemplary diagram illustrating the analysis of motion along a specific axis according to a method for axial motion magnification in a video according to an embodiment of the present invention, compared to a conventional motion magnification technique.

### DETAILED DESCRIPTION

The advantages and features of the present invention, and the methods for achieving them, will become clear with reference to the embodiments described in detail below in conjunction with the accompanying drawings. However, the present invention is not limited to the embodiments disclosed below and may be implemented in various different forms; these embodiments are provided only to make the disclosure of the present invention complete and to fully inform those skilled in the art of the scope of the invention. The present invention is defined only by the scope of the claims.

In describing the embodiments of the present invention, if it is determined that a detailed description of known functions or configurations may unnecessarily obscure the gist of the present invention, the detailed description will be omitted. The terms used below are defined in consideration of the functions in the embodiments of the present invention and may vary according to the intentions of users, operators, or customs. Therefore, their definitions should be based on the content throughout this specification.

A brief explanation of the terms used in this specification will be provided, followed by a detailed description of the present invention.

The terms used in this specification have been selected from generally widely used current terms as much as possible, in consideration of the functions of the present invention, but they may vary depending on the intentions of technicians in the field, legal precedents, the emergence of new technologies, and so on. Furthermore, in specific cases, there are also terms arbitrarily selected by the applicant, and in such cases, their meanings will be described in detail in the corresponding description section of the invention. Therefore, the terms used in the present invention should be defined based on the meaning they possess and the content throughout the present invention, rather than simply on their names.

Throughout the specification, when a part is said to “include” a component, it means that it can further include other components, not excluding them, unless there is a specific statement to the contrary.

Furthermore, the term ‘unit’ as used in the specification refers to a software or hardware component such as an FPGA or ASIC, and a ‘unit’ performs certain roles. However, ‘unit’ is not limited to software or hardware. A ‘unit’ may be configured to reside in an addressable storage medium and to be executed by one or more processors. Accordingly, as an example, a ‘unit’ includes components such as software components, object-oriented software components, class components, and task components, as well as processes, functions, attributes, procedures, subroutines, segments of program code, drivers, firmware, microcode, circuits, data, databases, data structures, tables, arrays, and variables. The functionality provided in the components and ‘units’ may be combined into a smaller number of components and ‘units’ or further separated into additional components and ‘units’.

Hereinafter, embodiments of the present invention will be described in detail with reference to the accompanying drawings so that those of ordinary skill in the art to which the present invention pertains can easily implement them.

FIG. 1 is a block diagram illustrating an exemplary axial motion magnification apparatus for a video according to an embodiment.

As shown in FIG. 1, the axial motion magnification apparatus 100 may include an input unit 110, an output unit 120, a processor 130, a memory 140, or a communication unit 160.

Hereinafter, for convenience of explanation, it will be described as an example that the axial motion magnification apparatus 100 includes the input unit 110, the output unit 120, the processor 130, the memory 140, or the communication unit 160, but it is not limited thereto. That is, each unit component may be provided outside the axial motion magnification apparatus 100 and operate in a manner that interacts with the axial motion magnification apparatus 100.

The input unit 110 may include a user interface for receiving commands, information, etc., used to control the axial motion magnification apparatus 100. Furthermore, the input unit 110 may be a hardware device (e.g., a keyboard, mouse, touchpad, etc.) that can directly receive commands, information, etc., used to control the axial motion magnification apparatus 100.

In one embodiment, the input unit 110 may receive information necessary for the axial motion magnification method from a user. Specifically, the user may input information including a plurality of images included in a video, information related to a motion magnification model, a training dataset for the motion magnification model, a motion magnification direction, a motion magnification target object, a motion magnification region, and a motion magnification factor through the input unit 110.

The output unit 120 may provide information including a plurality of images included in a video, information related to a motion magnification model, a training dataset for the motion magnification model, a motion magnification direction, a motion magnification target object, a motion magnification region, a motion magnification factor, and a magnification result to a user as visual information through an interface.

In one embodiment, the output unit 120 may display a plurality of images included in a video to a user and output an interface for selecting at least one of a motion magnification direction, a motion magnification target object, a motion magnification region, and a motion magnification factor. When at least one of the motion magnification direction, the motion magnification target object, the motion magnification region, and the motion magnification factor is selected by the user through the input unit 110, the output unit 120 may output the acquired magnification result reflecting the selected at least one to the user.

The processor 130 can generally control the operation of the axial motion magnification apparatus 100 to perform the present invention.

The processor 130 can load the axial motion magnification program 150 and information necessary for the execution of the axial motion magnification program 150 from the memory 140 to execute the axial motion magnification program 150.

The processor 130 can control the storage of data received from an external device via the communication unit 160 into the memory 140. Furthermore, the processor 130 can control the transmission and reception of information including a plurality of images included in a video, information related to a motion magnification model, a training dataset for the motion magnification model, a motion magnification direction, a motion magnification target object, a motion magnification region, a motion magnification factor, and a magnification result with an external device via the communication unit 160.

The processor 130 can acquire a magnification result for motion in a video using a pre-trained motion magnification model. The processor 130 can generate a training dataset for training the motion magnification model.

The processor 130 can train a neural network or model designed with machine learning or deep learning methods. To this end, the processor 130 can perform calculations for training a neural network, such as processing input data for training, extracting features from the input data, calculating errors, and updating the weights of the neural network using backpropagation.

In addition, the processor 130 may perform inference for a predetermined purpose using a model implemented as an artificial neural network.

The processor 130 may refer to a processing device such as a microprocessor, a central processing unit (CPU), a graphics processing unit (GPU), a processor core, a multiprocessor, an application-specific integrated circuit (ASIC), a field-programmable gate array (FPGA), or a microcontroller unit (MCU), but is not limited to the above-described embodiments.

The memory 140 can store the axial motion magnification program 150 and information necessary for the execution of the axial motion magnification program 150. Furthermore, the memory 140 may also store the processing results from the processor 130.

The axial motion magnification program 150 may refer to software including instructions programmed to perform the method according to the present invention.

The memory 140 can store information including a plurality of images included in a video, information related to a motion magnification model, a training dataset for the motion magnification model, a motion magnification direction, a motion magnification target object, a motion magnification region, a motion magnification factor, and a magnification result. Furthermore, the memory 140 can store information received from an external device via the communication unit 160.

The memory 140 may refer to a computer-readable storage medium such as magnetic media (e.g., hard disk, floppy disk, and magnetic tape), optical media (e.g., CD-ROM, DVD), magneto-optical media (e.g., floptical disk), and hardware devices specially configured to store and execute program instructions, such as random access memory (e.g., DRAM, SRAM), flash memory, but is not limited to the above-described embodiments.

The communication unit 160 may be a wireless communication module capable of performing wireless communication by adopting communication methods such as CDMA, GSM, W-CDMA, TD-SCDMA, WiBro, LTE, EPC, 5G, wireless LAN, Wi-Fi, Bluetooth, Zigbee, Wi-Fi Direct (WFD), Ultra Wide Band (UWB), Infrared Data Association (IrDA), Bluetooth Low Energy (BLE), or Near Field Communication (NFC), but is not limited to the above-described embodiments.

Furthermore, the information input and output through the input unit 110 and the output unit 120, the information stored in the memory 140, and the information transmitted and received through the communication unit 160 include all information related to the present invention and are not limited to the above-described embodiments.

In one embodiment, the axial motion magnification apparatus 100 or the axial motion magnification program 150 may include a predetermined artificial intelligence model for performing the axial motion magnification method according to an embodiment, and this artificial intelligence model may include an artificial neural network (ANN). Furthermore, the axial motion magnification apparatus 100 may include a plurality of neurons and a plurality of synapse circuits. Here, each neuron may include a register, which is an ultra-high-speed memory that temporarily stores data, a microprocessor, and at least one input, and each synapse circuit may include a memory that stores weights, and each neuron may be connected to at least one other neuron through a synapse circuit.

Meanwhile, various types of modules or models may be implemented in the memory 140. When these modules or models are executed by the processor 130 to be described later, the intended functions are performed. In this case, at least one of these modules or models may be implemented based on rules or on an artificial intelligence network.

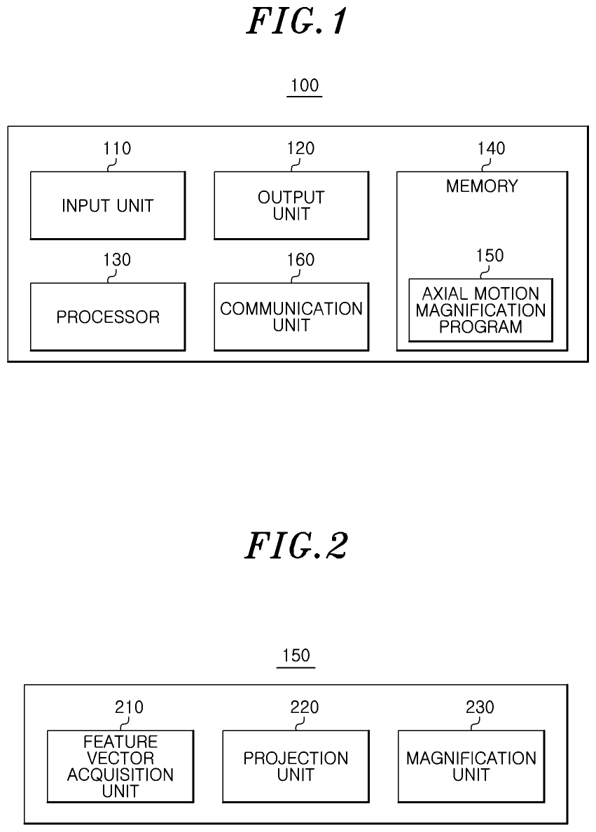

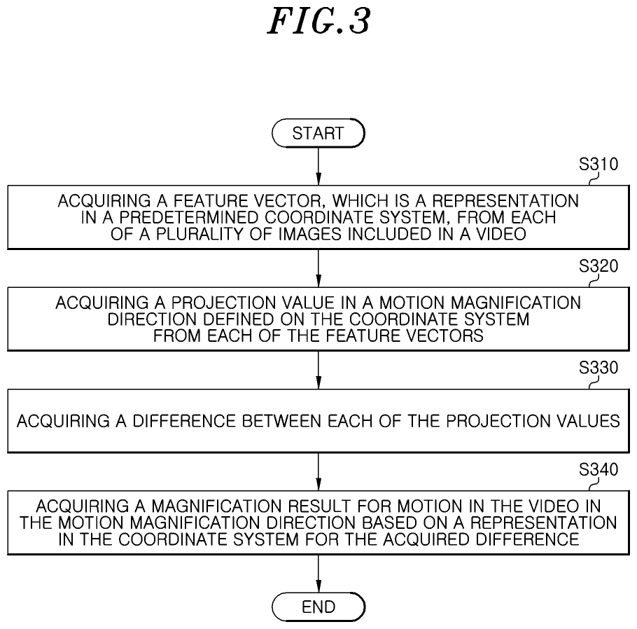

The function or operation of the axial motion magnification program 150 will be described in detail through FIG. 2.

FIG. 2 is a block diagram illustrating exemplary functions of an axial motion magnification program for a video.

As shown in FIG. 2, the axial motion magnification program 150 may include a feature vector acquisition unit 210, a projection unit 220, and a magnification unit 230. The feature vector acquisition unit 210, the projection unit 220, and the magnification unit 230 are exemplary divisions of the functions of the axial motion magnification program 150 and are not limited thereto.

According to embodiments, the functions of each of the feature vector acquisition unit 210, the projection unit 220, and the magnification unit 230 can be merged/separated and may be implemented as a series of instructions included in at least one program.

The feature vector acquisition unit 210, the projection unit 220, and the magnification unit 230 may be implemented by the processor 130 and may refer to a data processing device embedded in hardware, having physically structured circuits to perform functions represented by code or commands included in the axial motion magnification program 150 stored in the memory 140.

The feature vector acquisition unit 210, the projection unit 220, and the magnification unit 230 may perform interaction with a user through an interface associated with the input unit 110 or the output unit 120.

The feature vector acquisition unit 210 can acquire a feature vector, which is a representation in a predetermined coordinate system, from each of a plurality of images included in a video. Here, the coordinate system may be an orthogonal coordinate system on a two-dimensional plane. For example, the feature vector may be represented by x-axis coordinates and y-axis coordinates.

The projection unit 220 can acquire projection values in a motion magnification direction defined on the coordinate system from each of the feature vectors.

The projection value acquired by the projection unit 220 may include a component along the motion magnification direction and a component in a direction perpendicular to the motion magnification direction.

The projection unit 220 can acquire a difference between each of the projection values.

The magnification unit 230 can acquire a magnification result for motion in the video in the motion magnification direction based on a representation in the coordinate system for the acquired difference.

The difference between each of the projection values acquired by the projection unit 220 may include a first difference between respective projection values obtained by projecting each feature vector onto the component along the motion magnification direction, and a second difference between respective projection values obtained by projecting each feature vector onto the component in the direction perpendicular to the motion magnification direction.

Accordingly, the magnification unit 230 can acquire the magnification result by magnifying the first difference in the motion magnification direction and magnifying the second difference in the direction perpendicular to the motion magnification direction.

In one embodiment, the magnification unit 230 may acquire the magnification result by reflecting a first motion magnification factor input by a user to the first difference between respective projection values obtained by projecting each feature vector onto the component along the motion magnification direction, and reflecting a second motion magnification factor input by the user to the second difference between respective projection values obtained by projecting each feature vector onto the component in the direction perpendicular to the motion magnification direction. For example, if the first motion magnification factor is 2 and the second motion magnification factor is 0, the magnification unit 230 can magnify the motion in the video by 2 times in the motion magnification direction. As another example, if the first motion magnification factor is 2 and the second motion magnification factor is 2, the magnification unit 230 can magnify by 2V2 times in an intermediate direction between the motion magnification direction and the direction perpendicular to the motion magnification direction (a direction differing by 45 degrees from the motion magnification direction).

In one embodiment, the motion magnification direction may be acquired from a user or a pre-trained motion direction recommendation model. Specifically, training input data and training ground truth data may be used in the training process of the motion direction recommendation model. Furthermore, the training input data may include a video of an object having motion, and the training ground truth data may include information on the motion direction requiring magnification in the video of the training input data.

The plurality of images may include a plurality of objects or a plurality of regions. In one embodiment, the magnification unit 230 may select one of a predetermined object or a predetermined region included in the plurality of images. Accordingly, the magnification unit 230 can magnify the motion for the selected predetermined object or the selected predetermined region.

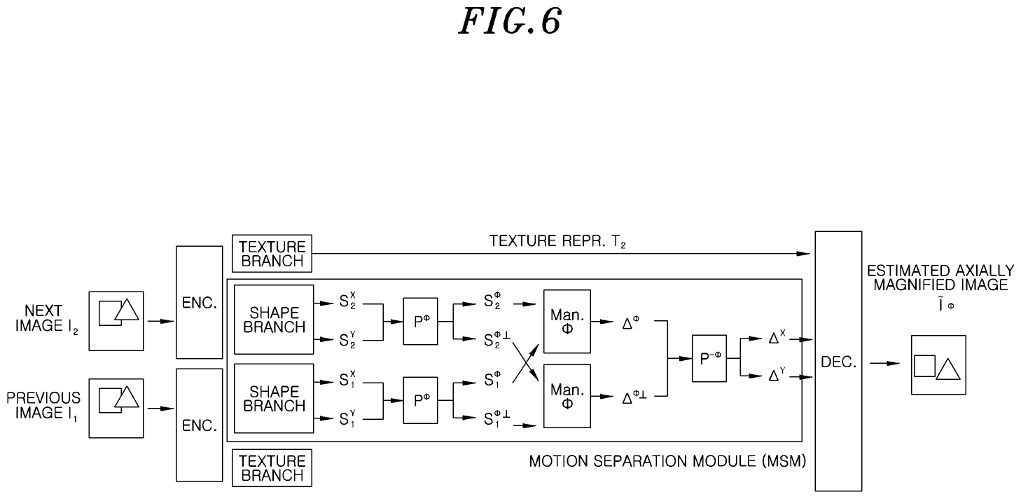

The magnification unit 230 can acquire a magnification result for motion in a video in the motion magnification direction using a pre-trained motion magnification model. The pre-trained motion magnification model can be trained according to the training method of FIG. 5, and a description thereof will be given in FIG. 5.

FIG. 3 is a flowchart illustrating an exemplary method for axial motion magnification in a video according to an embodiment. Hereinafter, the method for axial motion magnification in a video will be described on the premise that it is performed by an axial motion magnification apparatus.

As shown in FIG. 3, the method for axial motion magnification in a video according to an embodiment is performed by including acquiring a feature vector, which is a representation in a predetermined coordinate system, from each of a plurality of images included in a video (S310); acquiring projection values in a motion magnification direction defined on the coordinate system from each of the feature vectors (S320); acquiring a difference between each of the projection values (S330); and acquiring a magnification result for motion in the video in the motion magnification direction based on a representation in the coordinate system for the acquired difference (S340).

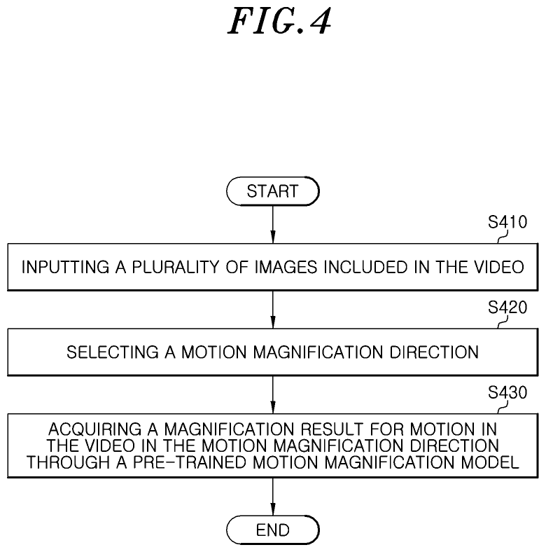

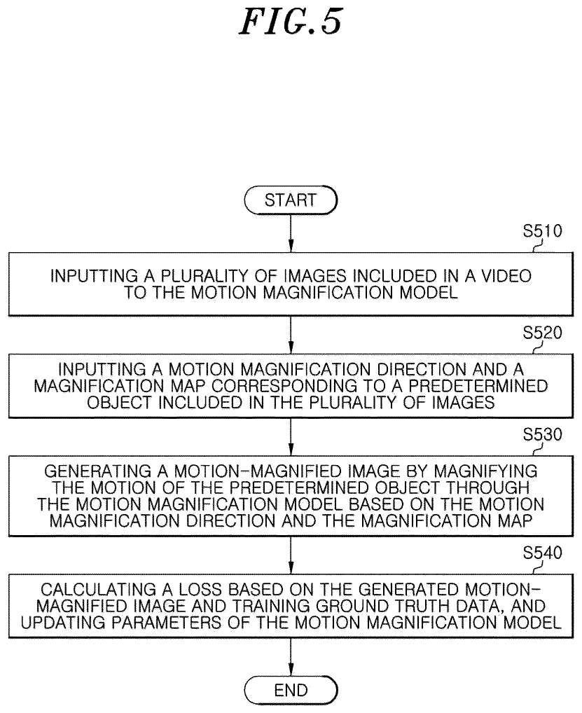

FIG. 4 is a flowchart illustrating an exemplary method for axial motion magnification in a video according to another embodiment.

As shown in FIG. 4, the method for axial motion magnification in a video according to another embodiment is performed by including inputting a plurality of images included in a video (S410); selecting a motion magnification direction (S420); and acquiring a magnification result for motion in the video in the motion magnification direction using a pre-trained motion magnification model (S430).

The pre-trained motion magnification model can be trained according to the training method of FIG. 5, and a description thereof will be given in FIG. 5.

FIG. 5 is a flowchart illustrating an exemplary method for training an axial motion magnification model for a video according to yet another embodiment.

As shown in FIG. 5, the method for training an axial motion magnification model for a video according to yet another embodiment is performed by including inputting a plurality of images included in a video to the motion magnification model (S510); inputting a motion magnification direction and a magnification map corresponding to a predetermined object included in the plurality of images (S520); generating a motion-magnified image by magnifying the motion of the predetermined object using the motion magnification model based on the motion magnification direction and the magnification map (S530); and calculating a loss based on the generated motion-magnified image and training ground truth data, and updating parameters of the motion magnification model (S540).

The training ground truth data is correct answer data for training the artificial intelligence model and may include ground truth or label data.

Here, the generating the motion-magnified image may be performed by including acquiring a feature vector, which is a representation in a predetermined coordinate system, from each of a plurality of images included in the video; acquiring projection values in a motion magnification direction defined on the coordinate system from each of the feature vectors; acquiring a difference between each of the projection values; and acquiring a magnification result for motion in the video in the motion magnification direction based on a representation in the coordinate system for the acquired difference.

The coordinate system may be an orthogonal coordinate system on a two-dimensional plane.

The projection value may include a component along the motion magnification direction and a component in a direction perpendicular to the motion magnification direction.

Alpha blending is a method of overlaying an area corresponding to a predetermined object included in another image onto one image, and can be performed using a layer image and a layer mask.

The plurality of images may include a first image and a second image in a consecutive frame relationship with the first image. In this case, the first image may be generated based on a plurality of images included in a dataset and a plurality of layer masks respectively corresponding to objects within each image. Furthermore, the second image may be generated based on the first image and a layer mask to which a translation determined by a predetermined algorithm has been applied. Here, the predetermined algorithm may be configured to include an arbitrarily value for a translation each time it is executed.

In one embodiment, the training ground truth data may be generated using alpha blending. Specifically, when the motion magnification direction is determined by a predetermined algorithm, the training ground truth data may be generated by magnifying the motion of a predetermined object based on the arbitrarily determined motion magnification direction and a motion magnification factor applied to a layer mask corresponding to the first image and the second image. Here, the predetermined algorithm may be configured to include an arbitrarily value for a motion magnitude or a motion direction each time it is executed.

The magnification map may be generated based on a motion magnification factor and a layer mask corresponding to the first image and the second image.

In one embodiment, as an image to be magnified is input to the motion magnification model trained by the method for training an axial motion magnification model for a video according to FIG. 5, an image in which motion is magnified in a predetermined direction can be output. For example, a user may input a desired predetermined angle and motion magnification factor through means such as a prompt or a user interface (UI) along with the image to be magnified, and the motion of the image to be magnified may be magnified based on the input angle and motion magnification factor.

In one embodiment, the aforementioned motion-magnified image may be provided to a user through a display device. On the display device where the motion-magnified image is output, the user can additionally input an angle or a motion magnification factor through a mouse or a touchpad, and the motion can be further magnified corresponding to the additionally input angle or motion magnification factor.

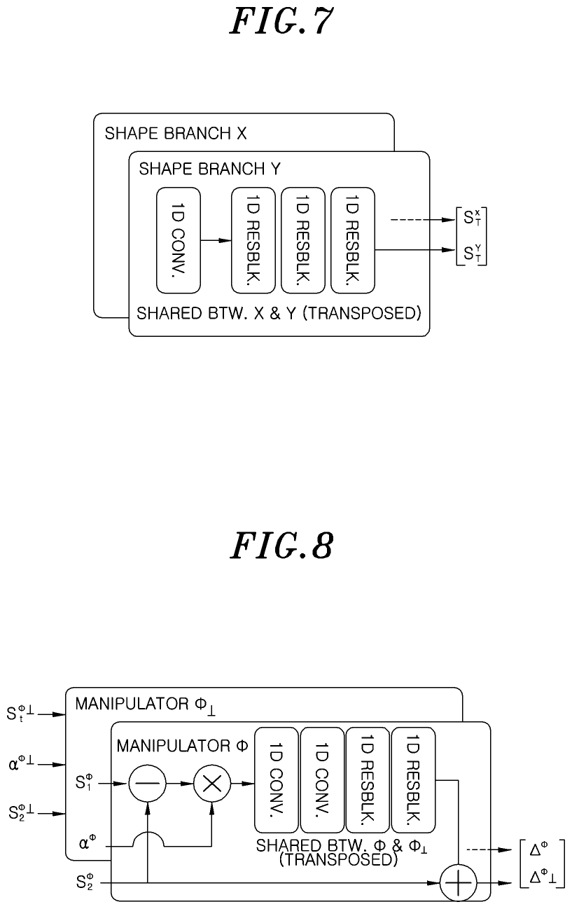

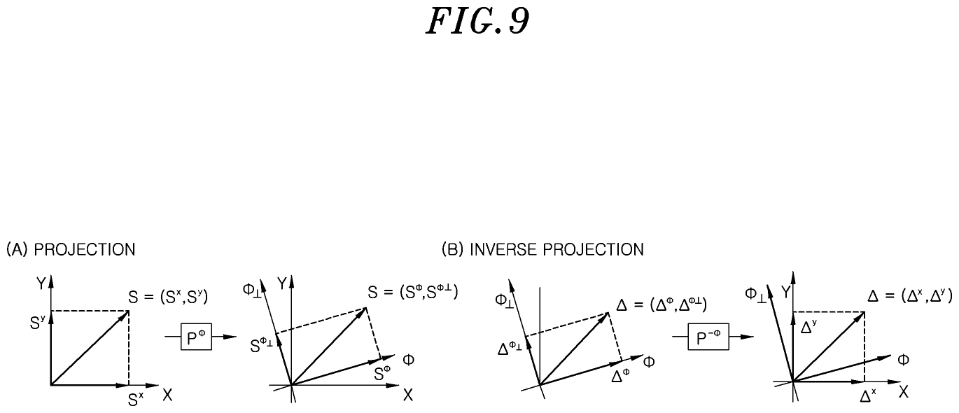

FIG. 6 is an exemplary diagram illustrating the structure of an axial motion magnification model for a video according to an embodiment, FIG. 7 is an exemplary diagram illustrating a shape branch included in the axial motion magnification model for a video according to FIG. 6, and FIG. 8 is an exemplary diagram illustrating a manipulator included in the axial motion magnification model for a video according to FIG. 6. Hereinafter, the axial motion magnification model for a video according to an embodiment will be described with reference to FIGS. 6 to 8.

The indices related to the axial motion magnification model for a video shown in FIG. 6 can be defined as follows:
Iᵢ: image of the i-th frame (i is 1 or 2, where 1 is referred to as previous, and 2 as next)
Tᵢ: texture representation of the i-th frame
Enc.: encoder
Dec.: decoder
Sᵢ^{r}: shape representation in the r-axis direction in the i-th frame
P^{Ø}: projection layer (projects the shape representation in the direction of the unit vector corresponding to angle Ø)
Δ^{T}: calculates the difference in shape representation in the r-axis direction
Ĩ^{Ø}: axially magnified image

The axial motion magnification model for a video may include at least some of an encoder, a shape branch, a manipulator, and a decoder.

The encoder (Enc.) can output a feature from an input image. The output feature can be input to a motion separation module (MSM) that includes a texture branch, a shape branch, and a manipulator (Man.). The shape branch and the manipulator can apply the same one-dimensional (1D) convolution to two axes respectively, to manipulate the representation of one axis and an axis perpendicular to it.

The axial motion magnification model for a video according to an embodiment may include a model implemented in a predetermined artificial neural network manner. Specifically, the encoder and decoder can be implemented through a CNN-based model, and the shape branch and manipulator can be implemented based on a 1D convolution layer.

Referring to FIG. 7, the shape branch can extract shape representations along the x-axis and y-axis by using a weight-shared one-dimensional convolution on the feature output from the encoder. The shape representation may be provided to a projection layer P^{Ø} to generate axial shape representations

$${S}_{t}^{Φ} and {S}_{t}^{Φ ⊥} .$$

Referring to FIG. 8, the manipulator can calculate the difference in shape representations and magnify the calculated difference in shape representations based on an axial magnification factor. Specifically, the manipulator can calculate a difference Δ in shape representations for the Φ and Φ⊥ directions by using an axial magnification factor or a magnification map on the shape representations in a direction parallel to the angle Φ and a direction perpendicular to the angle Φ (Φ⊥) after passing through the projection layer.

The inverse projection layer P^{-φ} can project the difference of the magnified shape representations back onto the x-axis and y-axis. Finally, the decoder can generate an axially magnified magnification result from the outputs of the texture branch and the motion separation module.

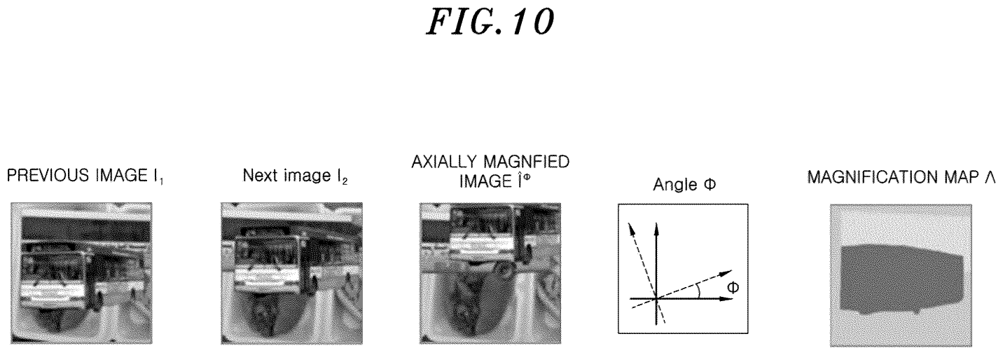

FIG. 9 is an exemplary diagram illustrating the concept of projection (a) and inverse projection (b) of an axial motion magnification model for a video.

Referring to FIG. 9 (a), the projection layer can project a shape representation S expressed by the x-axis and y-axis, i.e., S=(S^{x}, S^{y}), onto the Φ and Φ⊥ directions, thereby causing the shape representation S to be expressed by Φ and Φ⊥. Furthermore, referring to FIG. 9 (b), the inverse projection layer can project a shape representation difference Δ expressed by Δ=(Δ^{Φ}, Δ^{Φ⊥}) onto the x-axis and y-axis directions, thereby causing the shape representation difference Δ to be expressed by the x-axis and y-axis.

FIG. 10 is an exemplary diagram illustrating a training dataset for training an axial motion magnification model for a video.

Referring to FIG. 10, the training dataset may include a previous image I1, a next image 12, an axially magnified image Ĩ^{Ø}, a motion magnification direction Φ, and a magnification map Λ. Here, the magnification map may be a map indicating a region corresponding to an object that is the target of motion magnification included in the image.

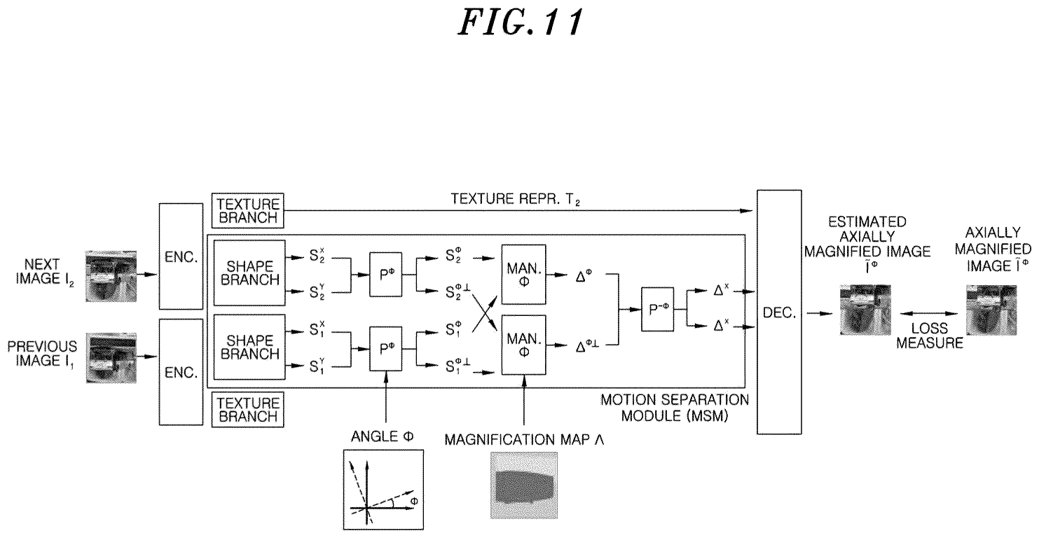

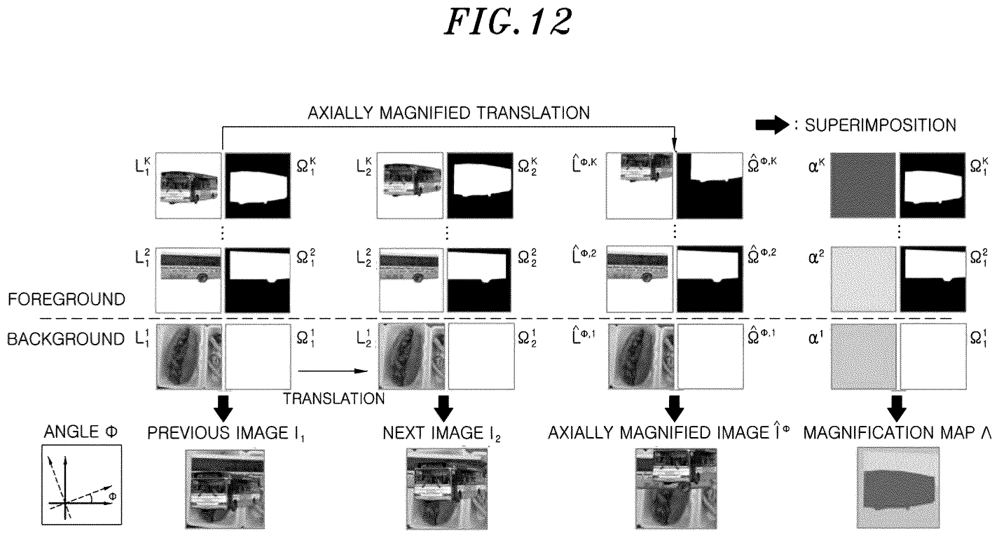

FIG. 11 is an exemplary diagram illustrating the training of an axial motion magnification model for a video using a motion magnification direction and a magnification map.

First, images I₁, I₂ are input to an encoder, then fed into a texture branch to extract T₂, and input to a shape branch to extract a shape representation.

Next, a difference Δ in shape representations can be extracted through a motion separation module based on a motion magnification direction Ø and a magnification map Λ.

Finally, an axially magnified image Ĩ^{Ø} can be predicted through a decoder, and by comparing it with the ground truth axially magnified image Î^{Ø}, a loss can be measured and the model's parameters can be updated.

FIG. 12 is an exemplary diagram illustrating the generation of a training dataset for training an axial motion magnification model for a video.

First, a layer image and a layer mask can be acquired from a dataset. A previous image can be synthesized by randomly placing the layer image and layer mask and using alpha blending.

Next, a next image can be synthesized by applying a random translation to the layer image and layer mask corresponding to the previous image and using alpha blending.

Next, an axially magnified translation is applied based on a randomly obtained angle φ and an axial magnification factor α for each layer, and an axially magnified image is generated through alpha blending (ground truth).

Finally, a magnification map can be generated based on the axial magnification factor α of each layer and the layer mask.

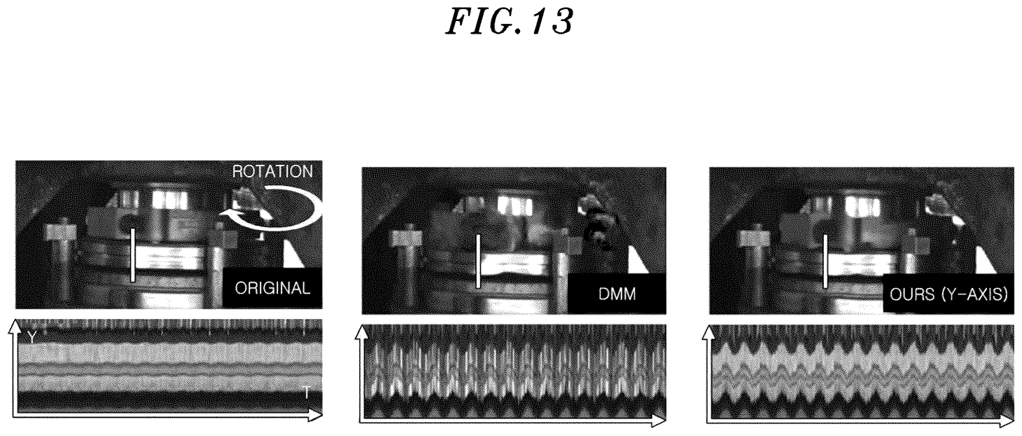

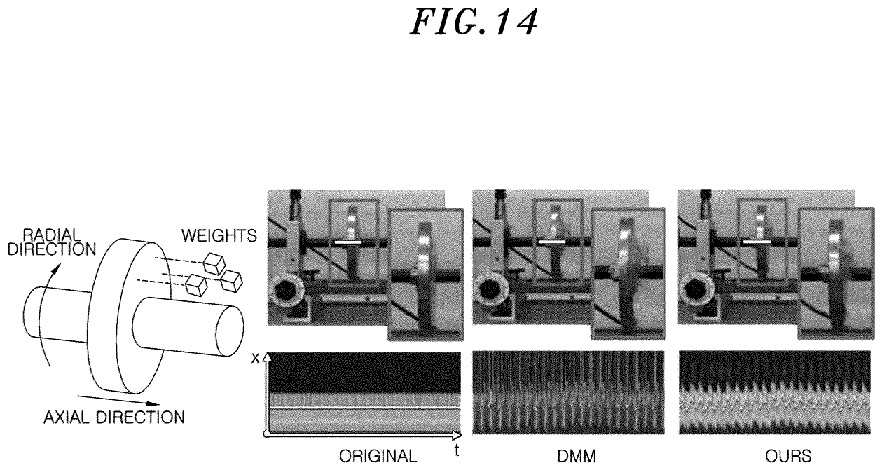

FIG. 13 is an exemplary diagram illustrating the analysis of the rotating motion of a rotating machine using a conventional motion magnification technique and a method for axial motion magnification in a video according to an embodiment of the present invention, respectively.

As shown in FIG. 13, when a rotating machine rotates axially, it may be more important to analyze the motion in the Y-axis direction than the vibration in the rotational direction for failure diagnosis of the rotating machine. A conventional motion magnification method, DMM, amplifies both the rotational motion and the Y-axis direction motion, and it may be difficult to analyze the Y-axis direction motion due to the amplified rotational motion. According to the method for axial motion magnification in a video according to an embodiment of the present invention, by magnifying only the Y-axis motion, the analysis of the Y-axis motion can be facilitated.

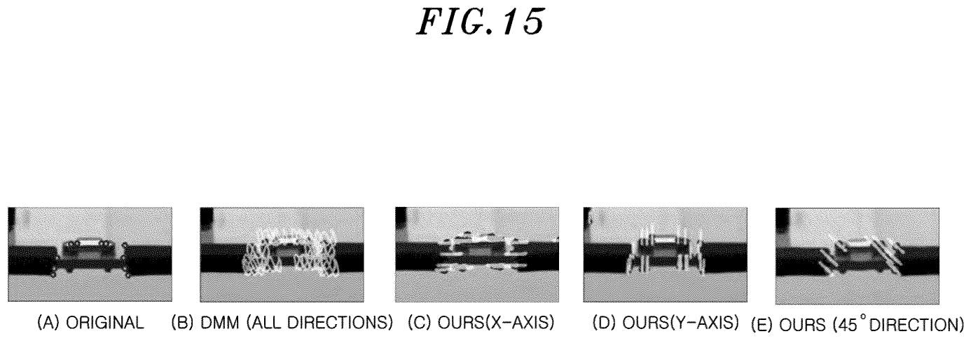

FIG. 14 is an exemplary diagram illustrating an apparatus for simulating a motor shaft and the motion analysis results thereof, using a conventional motion magnification technique and a method for axial motion magnification in a video according to an embodiment of the present invention.

A weight imbalance situation was created by arbitrarily adding weight to one side of a rotating blade, and the results from a conventional motion magnification technique (DMM) that amplifies motion in all directions were compared with the results from the method for axial motion magnification in a video according to an embodiment of the present invention, which magnified only the motion in the axial direction. Referring to FIG. 14, it can be confirmed that DMM is affected by the motion in the radial direction, which has a relatively large motion magnitude, making the magnified result not easy to analyze. In contrast, according to the method for axial motion magnification in a video according to an embodiment of the present invention, it can be seen that by minimizing the influence of motion in the radial direction and magnifying only the motion in the axial direction, a magnification result that is easy to analyze can be obtained.

FIG. 15 is an exemplary diagram illustrating the analysis of motion along a specific axis according to a method for axial motion magnification in a video according to an embodiment of the present invention, compared to a conventional motion magnification technique. In this case, the trajectory of motion was displayed on the image by tracking the motion using the Kanade-Lucas-Tomasi (KLT) tracker.

The motion in the original video may be too subtle to analyze with the naked eye. Furthermore, although the magnified motion can be perceived with the conventional motion magnification technique (DMM) which amplifies motion in all directions, the motion is complex, and it may be difficult to accurately analyze the motion of the device with the magnified video alone.

According to the method for axial motion magnification in a video according to an embodiment of the present invention, only the motion in a specific direction input by a user can be magnified. Accordingly, the motion in a specific direction of a device with complex movements can be easily analyzed. Referring to FIG. 15, it can be seen that the motion of the device can be easily analyzed through the video visualizing the trajectory by magnifying the motion only in the x-axis (c), y-axis (d), and 45-degree direction (e), respectively.

The method for axial motion magnification in a video of the present invention can be applied to all fields where conventional motion magnification techniques can also be applied, such as failure diagnosis for structures, rotating machines, and fixed machines, or in the medical field. Specifically, the method for axial motion magnification in a video of the present invention can be applied to the pre-diagnosis of failures in pumps, compressors, machine bases, and piping in industrial plants, or to safety inspections for apartments, commercial buildings, and bridges installed over rivers.

As described above, according to an embodiment, complex and subtle movements of various structures or machines can be provided to a user concisely and clearly.

Furthermore, motion in a specific direction, which is difficult to analyze with conventional motion magnification techniques, can be accurately analyzed.

The above-described embodiments of the present invention can be implemented through various means. For example, the embodiments of the present invention can be implemented by hardware, firmware, software, or a combination thereof.

The combinations of each block in the attached block diagrams and each step in the flowcharts of the present invention may also be performed by computer program instructions. These computer program instructions can be loaded onto the encoding processor of a general-purpose computer, a special-purpose computer, or other programmable data processing equipment, so that the instructions executed through the encoding processor of the computer or other programmable data processing equipment create means for performing the functions described in each block of the block diagrams or each step of the flowcharts. These computer program instructions can also be stored in a computer-usable or computer-readable memory that can direct a computer or other programmable data processing equipment to implement functions in a specific way, so that the instructions stored in the computer-usable or computer-readable memory can also produce an article of manufacture containing instruction means for performing the functions described in each block of the block diagrams or each step of the flowcharts. The computer program instructions can also be loaded onto a computer or other programmable data processing equipment, so that a series of operational steps are performed on the computer or other programmable data processing equipment to create a computer-executed process, so that the instructions that execute the computer or other programmable data processing equipment can also provide steps for executing the functions described in each block of the block diagrams and each step of the flowcharts.

Furthermore, each block or each step may represent a part of a module, segment, or code that includes one or more executable instructions for executing a specified logical function(s). In some embodiments, the functions mentioned in the blocks or steps may also occur out of order. For example, two blocks or steps shown in succession may in fact be performed substantially simultaneously, or the blocks or steps may sometimes be performed in reverse order, depending on the corresponding function.

The above description is merely an exemplary explanation of the technical idea of the present invention, and various modifications and variations will be possible for those of ordinary skill in the art to which the present invention pertains without departing from the essential qualities of the present invention. Therefore, the embodiments disclosed in the present invention are not for limiting the technical idea of the present invention but for explaining it, and the scope of the technical idea of the present invention is not limited by these embodiments. The protection scope of the present invention should be interpreted by the following claims, and all technical ideas within the equivalent scope thereof should be interpreted as being included in the scope of rights of the present invention.

What is claimed is:

1. A method for axial motion magnification in a video, to be performed by an axial motion magnification apparatus, the method comprising:
acquiring a feature vector, which is a representation in a predetermined coordinate system, from each of a plurality of images in a consecutive frame relationship included in the video;
acquiring projection values in a motion magnification direction defined on the coordinate system from each of the feature vectors;
acquiring a difference between the projection values; and
acquiring a magnification result for motion in the video in the motion magnification direction based on a representation of the acquired difference in the coordinate system.

2. The method of claim 1, wherein the coordinate system is an orthogonal coordinate system on a two-dimensional plane.

3. The method of claim 1, wherein the projection values include a component along the motion magnification direction and a component in a direction perpendicular to the motion magnification direction.

4. The method of claim 1, wherein the motion magnification direction is acquired from a user or a pre-trained motion direction recommendation model.

5. The method of claim 4, wherein training input data and training ground truth data are used in a training process of the motion direction recommendation model,
wherein the training input data includes a video of an object having motion, and
wherein the training ground truth data includes information on a motion direction requiring magnification in the video of the training input data.

6. The method of claim 1, wherein the difference includes a first difference between respective projection values obtained by projecting each feature vector onto a component along the motion magnification direction, and a second difference between respective projection values obtained by projecting each feature vector onto a component in a direction perpendicular to the motion magnification direction.

7. The method of claim 6, wherein the magnification result is acquired by magnifying the first difference in the motion magnification direction and magnifying the second difference in the direction perpendicular to the motion magnification direction.

8. The method of claim 7, wherein the magnification reflects a first motion magnification factor input by a user to the first difference, and reflects a second motion magnification factor input by the user to the second difference.

9. The method of claim 1, wherein the plurality of images includes a plurality of objects or a plurality of regions, further comprising selecting one of a predetermined object or a predetermined region included in the plurality of images,
wherein in the acquiring the magnification result, motion for the selected predetermined object or the selected predetermined region is magnified.

10. A method for axial motion magnification in a video, to be performed by an axial motion magnification apparatus, the method comprising:
inputting a plurality of images included in the video;
selecting a motion magnification direction; and
acquiring a magnification result for motion in the video in the motion magnification direction using a pre-trained motion magnification model.

11. The method of claim 10, wherein the motion magnification model is pre-trained using a training method comprising:
inputting a plurality of images included in a video to the motion magnification model;
inputting a motion magnification direction and a magnification map corresponding to a predetermined object included in the plurality of images;
generating a motion-magnified image by magnifying the motion of the predetermined object using the motion magnification model based on the motion magnification direction and the magnification map; and
calculating a loss based on the generated motion-magnified image and training ground truth data, and updating parameters of the motion magnification model.

12. The method of claim 11, wherein the plurality of images include a first image and a second image in a consecutive frame relationship with the first image,
wherein the first image is generated based on a plurality of images included in a dataset and a plurality of layer masks respectively corresponding to objects within each image, and
wherein the second image is generated based on the first image and a layer mask to which a translation determined by a predetermined algorithm has been applied.

13. The method of claim 12, wherein the motion magnification direction is determined by a predetermined algorithm, and
wherein the training ground truth data is generated by magnifying the motion of the predetermined object based on the arbitrarily determined motion magnification direction and a motion magnification factor applied to a layer mask corresponding to the first image and the second image.

14. The method of claim 12, wherein the magnification map is generated based on a motion magnification factor and a layer mask corresponding to the first image and the second image.

15. A non-transitory computer-readable storage medium storing computer-executable instructions, wherein the computer-executable instructions, when executed by a processor, cause the processor to perform a method comprising:
acquiring a feature vector, which is a representation in a predetermined coordinate system, from each of a plurality of images in a consecutive frame relationship included in a video;
acquiring projection values in a motion magnification direction defined on the coordinate system from each of the feature vectors;
acquiring a difference between the projection values; and
acquiring a magnification result for motion in the video in the motion magnification direction based on a representation of the acquired difference in the coordinate system.

16. The non-transitory computer-readable storage medium of claim 15, wherein the projection values include a component along the motion magnification direction and a component in a direction perpendicular to the motion magnification direction.

17. The non-transitory computer-readable storage medium of claim 15, wherein the motion magnification direction is acquired from a user or a pre-trained motion direction recommendation model.

18. The non-transitory computer-readable storage medium of claim 17, wherein training input data and training ground truth data are used in a training process of the motion direction recommendation model,
wherein the training input data includes a video of an object having motion, and
wherein the training ground truth data includes information on a motion direction requiring magnification in the video of the training input data.

19. The non-transitory computer-readable storage medium of claim 15, wherein the difference includes a first difference between respective projection values obtained by projecting each feature vector onto a component along the motion magnification direction, and a second difference between respective projection values obtained by projecting each feature vector onto a component in a direction perpendicular to the motion magnification direction.

20. The non-transitory computer-readable storage medium of claim 15, wherein the plurality of images includes a plurality of objects or a plurality of regions,
wherein the method further comprises selecting one of a predetermined object or a predetermined region included in the plurality of images, and
wherein in the acquiring the magnification result, motion for the selected predetermined object or the selected predetermined region is magnified.
